(19) United States
(12) Patent Application Publication
(10) Pub. No.: US 2008/0190401 A1
(43) Pub. Date: Aug. 14, 2008

(54) Helico-conical immersed nanometer/FIR/magnetic fuel saver

(76) Inventor: Yixin Guo, Ronkonkoma, NY (US)

Correspondence Address: Yixin Guo, 256 Holbrook Ave, Ronkonkoma, NY, 11779, US

(21) Appl. No.: 11/717,846

(22) Filed: Mar. 14, 2007

Related U.S. Application Data
(60) Provisional application No. 60/900,737, filed on Feb. 12, 2007.

(51) Int. Cl. F02M 27/04

(52) U.S. Cl. 123/538

(57) ABSTRACT

The invention as disclosed herein is a helico-conical immersed FIR/magnetic fuel saver possessing the following characteristics: it includes a set of fuel-activating ceramic balls or pieces, and high-field magnetic balls or pieces, which are placed within the fuel tank and immersed in the fuel. The fuel-activating ceramic balls or pieces are set in a compact arrangement with small spaces between, and fixed into a multilayer pagoda shaped structure by multilayer helico-conical soft steel wires as the shelf or multilayer helico-conical pipe. The said fuel-activating ceramic balls or pieces adopt any one of the following types: (1) FIR (Far Infrared Ray) ceramic balls or pieces; (2) magnetic balls or pieces; (3) magnetic balls or pieces and FIR ceramic balls or pieces. This invention directly acts on the fuel by far infrared ray, high-intensity magnetic field or the combination of such emitted by the fuel-activating ceramic balls or pieces and magnetic balls or pieces, which will instantly moleculize the fuel molecule groups, catalyze the fuel molecules and thus meet the purpose of burning the fuel sufficiently. This invention adopts the multilayer helico-conical fuel saver is placed in the fuel tank, the quantity of which far exceeds that of a stick shaped fuel saver, which improves the fuel-saving effect by considerably increasing the acreage of interface between the fuel and the fuel saver.

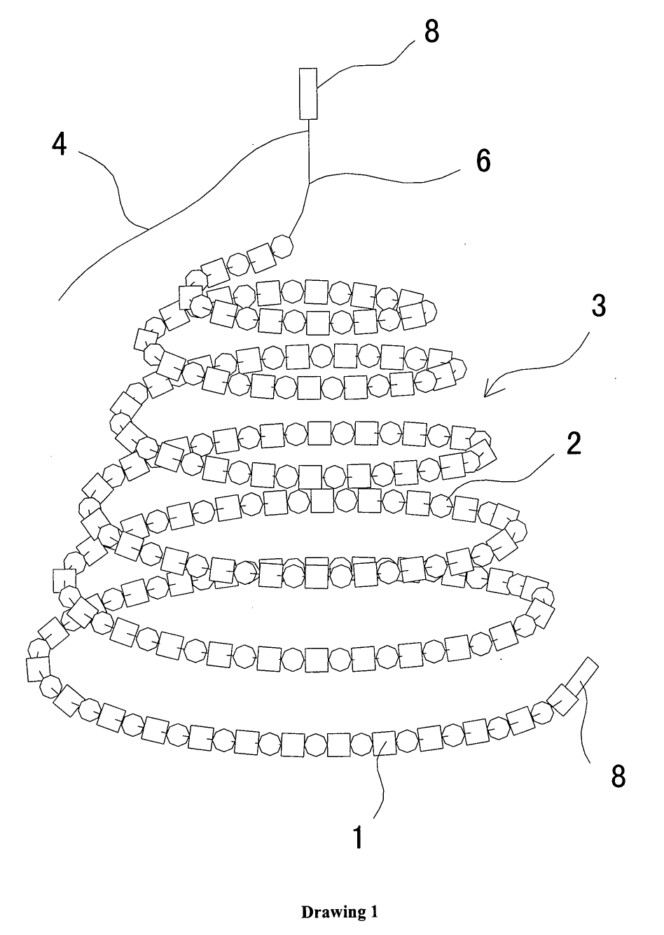

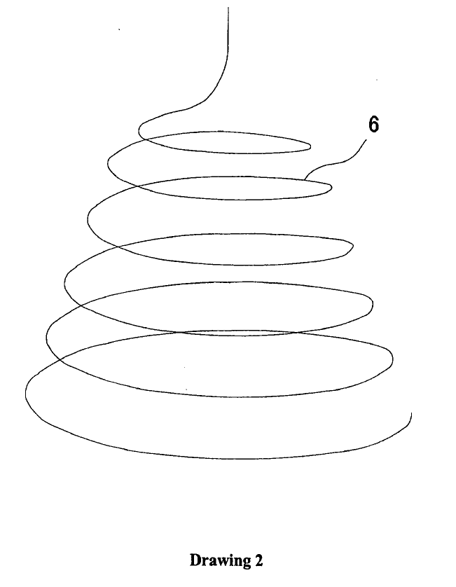

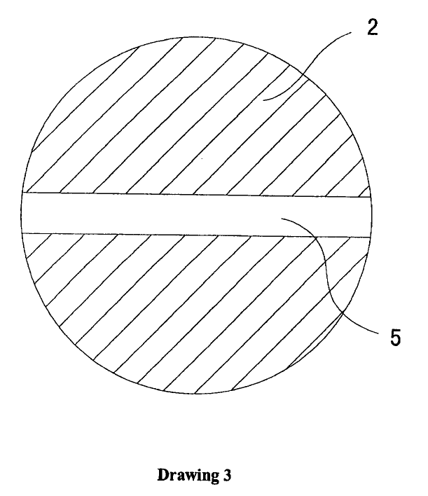

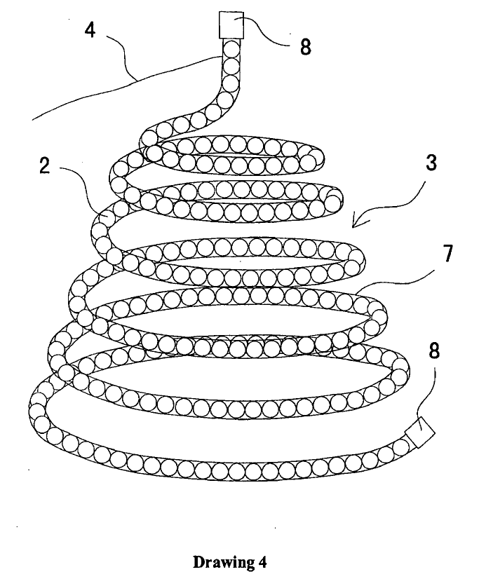

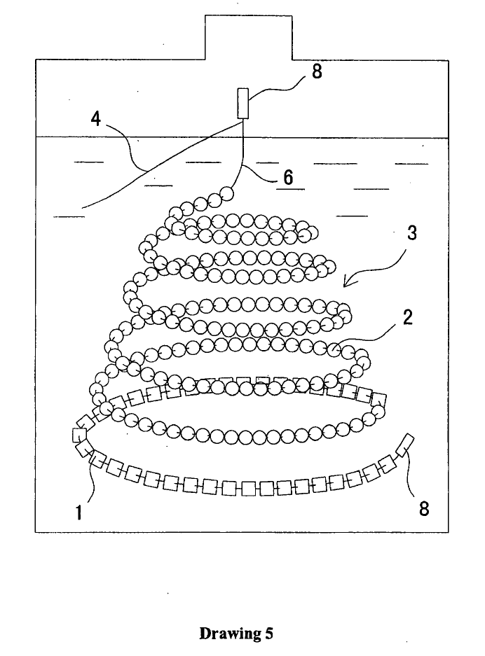

### FIELD OF THE INVENTION

This invention refers to a fuel saver that could be used in the internal combustion (IC) engines such as the automobile's gasoline engines and diesel engines. It specifically refers to an immersed FIR/magnetic fuel saver which shall be immersed into the fuel in the fuel tank.

### BACKGROUND OF THE INVENTION

Currently, there are two common types of fuel savers in the market: exterior loop type and connection type. The fuel saver of the exterior loop type usually consists of two semi-circular fuel saving parts, which are combined at the outer diameter of certain segment of the automobile's engine hose pipe and thus generate effects on the fuel flowing inside of the hose pipe by surrounding such outer diameter of the hose pipe. Such fuel saver usually meets the purpose of fuel saving by taking advantage of the principles of activation by high magnetic fields or/and FIR. However, the disadvantages in common possessed by these two fuel savers are as follows: 1. The high magnetic field or/and FIR will only have activation effects on the flowing-by fuel when the fuel is actually flow through the fuel saver, but will not act on the fuel that is not flowing through. 2. Due to such reason, the time that the fuel saver acts on the fuel is very short, which limits the activation and affect the fuel saving effects. Especially for the exterior loop type fuel saver, the hose pipe's insulation action substantially weakens the activation effect of the high magnetic field or/and FIR. Therefore, how to design a fuel saving product with better fuel saving effect by directly and effectively adopting the current fuel saving theory is the research subject of this invention herein.

### SUMMARY OF THE INVENTION

This invention provides a helico-conical immersed FIR/magnetic fuel saver with the purpose to design a fuel saving product with better fuel saving effect by adopting the current fuel saving theory in order to resolve the problem that people are urgently having with energy saving.

In order to reach the aforesaid goals, this invention adopts the following design: a helico-conical immersed FIR/magnetic fuel saver includes a set of fuel-activating ceramic balls or pieces and/or a set of magnetic balls or pieces which are placed within the fuel tank and immersed in the fuel. The fuel-activating ceramic balls or pieces are skewed and fixed onto a multilayer helico-conical soft steel wire shelf, or arrayed in multilayer helico-conical soft pipes, which forms such fuel-activating ceramic balls or pieces into a multilayer helico-conical pagoda shaped structure. The said fuel-activating ceramic balls or pieces adopt any one of the following types:

(1) FIR (Far Infrared Ray) ceramic balls or pieces;

(2) Magnetic balls or pieces

(3) Magnetic balls or pieces and FIR ceramic balls or pieces;

Related content of the aforesaid design are explained as follows:
1. In the aforesaid design, a bunch of high field ceramic balls or pieces are skewed into the bottom layer of the said multilayer helico-conical soft steel wire shelf in order to be fixed on the bottom of the iron fuel bank; or, a bunch of high field ceramic balls or pieces are arrayed on the bottom layer of the multilayer helico-conical soft pipes, which attaches and fixes the bottom layer of the fuel saver onto the bottom of the iron fuel tank.
2. In the aforesaid design, tourmaline and ceramic material are compounded to produce FIR (Far Infrared Ray) ceramic balls or pieces. The tourmaline is the only mineral to show permanent electricity on the earth and is also a natural (non-manufactured) source of negative ions and far infrared rays.
3. In the aforesaid design, a bunch of balls or pieces with anti-oil-sticking patches are skewed into the bottom layer of the said multilayer helico-conical soft steel wire shelf in order to be fixed on the bottom of the non-iron fuel bank; or, the anti-oil-sticking sticky patches are placed on the bottom layer of the multilayer helico-conical soft pipes, which fixes the bottom layer of the fuel saver onto the bottom of the non-iron fuel tank by the anti-oil-sticking sticky patches.
4. In the aforesaid design, the multilayer helico-conical soft pipes adopt metallic or non-metallic soft pipes.
5. In the aforesaid design, a suspension rope is placed on the top of the multilayer helico-conical pagoda shaped structure, which will be hooked out from the refueling hole of the fuel tank.
6. In the aforesaid design, in order to place the fuel saver into the fuel tank, put one end of the multilayer helico-conical pagoda structured fuel saver into the refueling hole of the fuel tank, and gradually fit the entire fuel saver into the fuel tank by spinning it into the tank. After entering the fuel tank, attach and fix the bigger end of the fuel saver on the bottom of the fuel tank by pulling the suspension rope on the top side of the fuel saver. The entire fuel-saver could be taken out of the fuel tank by pulling out the suspension rope and keep spinning it.
7. In the aforesaid design, the form of the helico-conical immersed FIR/magnetic fuel saver includes other shapes such as stick shape and helicon shape.
8. In the aforesaid design, the magnetic balls or pieces have to close each other for better fuel saving effect.
9. In the aforesaid design: the helico-conical immersed FIR/magnetic fuel saver may have a external protect sleeve.

Because of the application of the above described design, this invention possesses the following advantages comparing with other current techniques:

1. In this invention, the fuel-activating ceramic balls can immediately change the fuel molecular cluster into micro-molecular, activate the fuel molecular, increase FIR, improve the effect of high intensity magnetic field, help the fuel to combust completely and improve the fuel-saving effect by the direct and long-lasting interactions with the fuel while the fuel-saver is immersed in the fuel tank and keeping in the stereo pagoda shape.

2. In this invention, because the fuel-activating ceramic balls can directly touch the fuel, the movement during the driving can facilitate a thorough and sufficient interaction between the fuel with FIR and the high-intensity magnetic filed, and thereby improve the fuel-saving effect.

3. This invention can take advantage of a single one or the combination of FIR and high-intensity magnetic field. This invention has a flexible and customized design, especially of the immersed structure which creates a long-lasting thorough interaction between the fuel and the ceramic balls. This invention also creates a new method to install the fuel saver and a good precondition for further improving the fuel saving effect.

4. This invention significantly increases the surface area of the ceramic balls and the interaction area between the balls and the fuel as well by placing the multilayer pagoda structure in the fuel tank, which will improve the fuel-saving effect.

5. This invention can be placed into the fuel tank or pulled out of the fuel tank with a suspension rope, and can be attached on the bottom of the fuel tank by the effect of the high magnetic balls or fixed on the bottom of the fuel tank by the anti-oil-sticking sticky balls, which is very convenient for the installation.

### BRIEF DESCRIPTION OF THE DRAWINGS

Attached Drawing 1 is the stereo illustration of the fuel saver in Application Sample One (helicon soft steel wires);

Attached Drawing 2 is the primary illustration of the structure of the multilayer helicon-conical soft steel wires in Application Sample One;

Attached Drawing 3 is the cutaway illustration of the activating ceramic balls or magnetic balls;

Attached Drawing 4 is the stereo illustration of the fuel saver in Application Sample Two (helicon soft pipes);

Attached Drawing 5 is the application illustration of this invention.

In the above attached drawings: 1. high-intensity magnetic balls; 2. FIR ceramic balls; 3. the multilayer helicon-conical fuel saver; 4. suspension rope; 5. holes; 6. multilayer helicon-conical soft steel wires shelf; 7. multilayer helicon-conical soft pipes; 8. screw caps.

### DETAIL DESCRIPTION

The following is the further description of this invention basing on the attached drawings and application samples:

Application Sample One: as in the Drawing 1, the helicon-conical immersed FIR/magnetic fuel saver (with helicon soft steel wires structure) is mainly composed of one set of FIR ceramic balls 2, one set of high intensity magnetic balls 1 and a multilayer helicon-conical soft steel wires shelf 6 (see the Drawing 2). There is a hole 5 on the FIR ball 2 (or high intensity magnetic balls) as shown in Drawing 3. The multilayer helicon-conical soft steel wires shelf 6 is composed of the soft steel wires in a helicon shape as the base shelf supporting each FIR ceramic ball 2 and each high intensity magnetic ball 1 The high intensity magnetic ball 1 is made of the permanent magnet in neodymium, iron and boron material and located at the bottom of the multilayer helicon-conical soft steel wires shelf 6 by which it will has an attaching fixture effect as well as a magnetic effect to the fuel. The FIR ceramic balls 2 are going through from the bottom layer of the multilayer helicon-conical soft steel wires shelf 6 to the top part following the high intensity magnetic balls 1. There is a suspension rope 4 on the top of the fuel saver which can be pulled out from the refueling hole of the fuel tank when the fuel saver is needed to be taken out of the tank. There are whorls on the soft steel wire on the top of the pagoda structure and after the high intensity magnetic balls 1 and the FIR ceramic balls 2 go through the soft steel wire on the top of the pagoda structure, the screw cap 8 will lock the top part of the pagoda structure. There are small horizontal holes on the soft steel wire on the top of the pagoda structure through which the suspension rope 4 can go through and be fixed therein. For the non-iron material fuel tank, skewing a set of high intensity magnetic balls 1 with anti-oil-sticking sticky patches through the bottom of the multilayer helicon-conical soft steel wire shelf 6 can fix the bottom of the fuel saver on the bottom of the non-iron material fuel tank by the anti-oil-sticking sticky patches. See Drawing 5 for the application.

Application Sample Two: as in Drawing 4, the helicon-conical immersed FIR/magnetic fuel saver (with helicon soft pipe structure) is mainly composed of one set of FIR ceramic balls 2, one set of high intensity magnetic balls 1 and a multilayer helicon-conical soft pipe 7. The difference of Application Sample Two from Application Sample One is that it substitutes the multilayer helicon-conical soft steel wires shelf 6 with the multilayer helicon-conical soft pipe 7, and the FIR ceramic balls 2 and the high-intensity magnetic balls 1 are put in the helicon soft pipe which is made of metallic material or non-metallic material. For the non-iron material fuel tank, placing the anti-oil-sticking sticky patches on the bottom of the multilayer helicon-conical soft pipe 7 can fix the bottom of the fuel saver on the bottom of the non-iron material fuel tank. Other parts of this Application Sample are the same with Application Sample One, and thus the description of such will not be repeated here.

1. An invention of a helico-conical immersed FIR/magnetic fuel saver has the following features: it includes a set of fuel-activating ceramic balls or pieces which are placed within the fuel tank and immersed in the fuel. The fuel-activating ceramic balls or pieces are skewed and fixed onto a multilayer helico-conical soft steel wire shelf, or arrayed in multilayer helico-conical soft pipes, which forms such fuel-activating ceramic balls or pieces into a multilayer helico-conical pagoda shaped structure. The said fuel-activating ceramic balls or pieces adopt any one of the following types: (1) FIR (Fat Infrared Ray) ceramic balls or pieces; (2) magnetic balls or pieces (3) magnetic balls or pieces and FIR ceramic balls or pieces

2. The fuel saver as described in claim 1 has the following feature: tourmaline and ceramic material are compounded to produce FIR (Far Infrared Ray) ceramic balls or pieces.

3. The fuel saver as described in claim 1 has the following feature: a bunch of high field magnetic balls or pieces are skewed into the bottom layer of the said multilayer helico-conical soft steel wire shelf, which attaches and fixes the bottom layer of the fuel saver onto the bottom of the iron fuel tank.

4. The fuel saver as described in claim 1 has the following feature: a bunch of high field magnetic balls or pieces arrayed on the bottom layer of the multilayer helico-conical soft pipes, which attaches and fixes the bottom layer of the fuel saver onto the bottom of the iron fuel tank.

5. The fuel saver as described in claim 1 has the following feature: for the non-iron fuel tank, a bunch of balls or pieces with anti-oil-sticking patches are skewed into the bottom layer of the multilayer helico-conical soft steel wire shelf, which fixes the bottom layer of the fuel saver onto the bottom of the non-iron fuel tank by the anti-oil-sticking sticky patches.

6. The fuel saver as described in claim 1 has the following feature: for the non-iron fuel tank, the anti-oil-sticking patches are placed on the bottom layer of the multilayer helico-conical soft pipes, which fixes the bottom layer of the fuel saver onto the bottom of the non-iron fuel tank by the anti-oil-sticking patches.

7. The fuel saver as described in claim 1 has the following feature: the multilayer helico-conical soft pipes adopt metallic or non-metallic soft pipes.

8. The fuel saver as described in claim 1 through claim 6 has the following feature: a suspension rope is placed on the top of the multilayer helico-conical pagoda shaped structure, which will be hooked out from the refueling hole of the fuel tank.

9. The fuel saver as described in claim 1 has the following feature: the form of the helico-conical immersed FIR/magnetic fuel saver includes other shapes such as stick shape and helicon shape.

10. The fuel saver as described in claim 1 has the following feature: the magnetic balls or pieces have to close each other for better fuel saving effect.

11. The fuel saver as described in claim 1 has the following feature: the helico-conical immersed FIR/magnetic fuel saver may have an external protect sleeve.
